(19) United States
(12) Patent Application Publication
(10) Pub. No.: US 2018/0218276 A1
(43) Pub. Date: Aug. 2, 2018

(54) Optimizing Application Performance Using Finite State Machine Model and Machine Learning

(71) Applicant: Bank of America Corporation, Charlotte, NC (US)

(72) Inventor: Shakti Suman, Muzaffarpur (IN)

(21) Appl. No.: 15/419,310

(22) Filed: Jan. 30, 2017

(51) Int. Cl. G06N 5/04; G06N 99/00

(52) U.S. Cl. CPC G06N 5/047; H04L 67/02; G06N 99/005

(57) ABSTRACT

Aspects of the disclosure relate to optimizing application performance using a finite state model and machine learning. A computing platform may receive, via the communication interface, from a first user device, a web page request comprising task identification information. The computing platform may identify a task associated with the task identification information. The computing platform may receive, via the communication interface, from a machine learning server, a current transition cost associated with the task. The computing platform may select at least one optimization pattern used to optimize the current transition cost. The computing platform may generate one or more commands directing the machine learning server to execute the optimization pattern. The computing platform may send, via the communication interface, to the machine learning server, the one or more commands directing the machine learning server to execute the optimization pattern. The computing platform may calculate an updated current transition cost.

### BACKGROUND

Aspects of the disclosure relate to electrical computers, digital processing systems, and multicomputer data transferring. In particular, one or more aspects of the disclosure relate to optimizing application performance using a finite state machine model and machine learning.

As tasks and services performed by application become more complex, a greater amount of data needs to be transferred and compiled between a user device and subsequent application servers to perform a particular task. The greater the amount of data, the slower the task is performed. In many instances, however, users desire tasks, regardless of the complexity, to be performed as quickly and as efficiently as possible, and it may be difficult to provide quality and efficient performance when executing complex tasks.

### SUMMARY

Aspects of the disclosure provide effective, efficient, scalable, and convenient technical solutions that address and overcome the technical problems associated with optimizing application performance. In particular, one or more aspects of the disclosure provide techniques for optimizing application performance using a finite state machine model and machine learning.

In accordance with one or more embodiments, a computing platform having at least one processor, a memory, and a communication interface may receive, via the communication interface, from a first user device, a web page request comprising current web page identification information, new web page identification information, and task identification information. Subsequently, the computing platform may identify a task associated with the task identification information. Thereafter, the computing platform may receive, from a machine learning server, a current transition cost associated with the task, the current transition cost corresponding to an amount of resources used in transitioning between a current web page associated with the current web page identification information to a new web page associated with the new web page identification information. Then, the computing platform may select, based on the task and the current transition cost, at least one optimization pattern used to optimize the current transition cost. Subsequently, the computing platform may, in response to selecting the at least one optimization pattern, generate one or more commands directing the machine learning server to execute the at least one optimization pattern. Next, the computing platform may send, via the communication interface and to the machine learning server, the one or more commands directing the machine learning server to execute the at least one optimization pattern. Then, the computing platform may calculate, based on a time for the first user device to transition between the current web page to the new web page using the at least one optimization pattern executed by the machine learning server, an updated current transition cost. Afterwards, the computing platform may send, via the communication interface and to the machine learning server, the updated current transition cost.

In some embodiments, the computing platform may determine, based on the task, a first web page associated with a first link from the new web page and a second web page associated with a second link from the new web page. Subsequently, the computing platform may receive, from the machine learning server, a first transition cost associated with an amount of resources used in transitioning between the new web page to the first web page. Afterwards, the computing platform may select, based on the task and the first transition cost, at least one optimization pattern used to optimize the first transition cost. Thereafter, the computing platform may, responsive to selecting the at least one optimization pattern used to optimize the first transition cost, generate one or more commands directing the machine learning server to execute the at least one optimization pattern used to optimize the first transition cost. Then, the computing platform may send, via the communication interface and to the machine learning server, the one or more commands directing the machine learning server to execute the at least one optimization pattern used to optimize the first transition cost. Next, the computing platform may calculate, based on a first time for the first user device to transition between the new web page to the first web page using the at least one optimization pattern executed at the machine learning server, an updated first transition cost. After, the computing platform may send, via the communication interface and to the machine learning server, the updated first transition cost.

In some embodiments, in generating one or more commands directing the machine learning server to execute the at least one optimization pattern used to optimize the first transition cost, the computing platform may retrieve, from an application server and using a pre-fetch command, data associated with the first web page. After retrieving the data associated with the first web page, the computing platform may receive, from the first user device, a first web page request comprising a request for data associated with the first web page. Subsequently, the computing platform may send, to the first user device, the data associated with the first web page.

In some embodiments, in generating one or more commands directing the machine learning server to execute the at least one optimization pattern used to optimize the first transition cost, the computing platform may retrieve, from an application server, data associated with the first web page. Subsequently, the computing platform may compile, using a pre-compilation command, the data associated with the first web page. After compiling the data associated with the first web page, the computing platform may receive, from the first user device, a first web page request comprising a request for compiled data associated with the first web page. Next, the computing platform may send, to the first user device, the compiled data associated with the first web page.

In some embodiments, the computing platform may determine, based on the first web page and the second web page, a first application server where first data associated with the first web page and data associated with the second web page are stored and a second application server where second data associated with the first web page is stored. Subsequently, in generating one or more commands directing the machine learning server to execute the at least one optimization pattern used to optimize the first transition cost, the computing platform may receive a second web page request associated with the second web page. After receiving the second web page request, the computing platform may retrieve, from the application server and using a bundled service call command, the first data associated with the first web page and the data associated with the second web page. Subsequently, the computing platform may receive, from the first user device, a first web page request comprising a request for data associated with the first web page. Next, the computing platform may send, to the first user device, the first data associated with the first web page.

In some embodiments, in generating one or more commands directing the machine learning server to execute the at least one optimization pattern used to optimize the first transition cost, the computing platform may, after receiving the first web page request, retrieve, from the second application server and using the split service call command, the second data associated with the first web page. Subsequently, the computing platform may send, to the first user device, the second data associated with the first web page.

In some embodiments, the computing platform may generate a command directing an application server to compress data associated with the new web page using a content compression command to produce compressed data. Subsequently, the computing platform may send, to the application server, the command. Thereafter, in generating one or more commands directing the machine learning server to execute the at least one optimization pattern used to optimize the current transition cost, the computing platform may retrieve, from the application server, the compressed data associated with the new web page. After retrieving the compressed data, the computing platform may receive, from the first user device, a new web page request including a request for data associated with the new web page. Subsequently, the computing platform may transmit, to the first user device, the compressed data associated with the new web page.

In some embodiments, the computing platform may determine, based on the new web page, a first application server where a first image associated with the new web page is stored and a second application server where a second image associated with the new web page is stored. Subsequently, in generating one or more commands directing the machine learning server to execute the at least one optimization pattern used to optimize the current transition cost, the computing platform may retrieve, from the first application server and the second application server, the first image and the second image. Thereafter, the computing platform may combine the first image and the second image into a combined image. After combining the first image and the second image, the computing platform may receive, from the first user device, a new web page request comprising a request for the first image and the second image. Then, the computing platform may send, to the first user device, the combined image.

In some embodiments, the computing platform may receive, from the first user device, hardware specifications associated with the first user device's amount of computing power to process data. Subsequently, in generating one or more commands directing the machine learning server to execute the at least one optimization pattern used to optimize the current transition cost, the computing platform may determine, based on the new web page, a first priority associated with the new web page and a second priority associated with the new web page. Thereafter, the computing platform may determine, based on the first priority, the second priority, and the hardware specifications, a first percentage of computing power to perform the first priority and a second percentage of computing power to perform the second priority. Next, the computing platform may send, to the first user device, the first percentage and the second percentage.

In some embodiments, the computing platform may receive, via the communication interface and from a second user device, a second user web page request comprising second task identification information. Subsequently, the computing platform may identify, by comparing the task identification information received from the first user device and the second task identification information from the second user device, the task. Thereafter, the computing platform may receive, from the machine learning server, the updated current transition cost. Next, the computing platform may select, based on the task and the updated current transition cost, the at least one optimization pattern used to optimize the updated current transition cost. After, responsive to selecting the at least one updated optimization pattern, the computing platform may generate one or more commands directing the machine learning server to execute the at least one optimization pattern to optimize the updated current transition cost. Then, the computing platform may send, via the communication interface and to the machine learning server, the one or more commands directing the machine learning server to execute the at least one optimization pattern to optimize the current transition cost. Subsequently, the computing platform may calculate, based on a second time for the second user device to transition between the current web page to the new web page using the at least one optimization pattern executed by the machine learning server, a second updated current transition cost. After, the computing platform may send, via the communication interface and to the machine learning server, the second updated current transition cost.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A, 1B, and 1C depict an illustrative computing environment for optimizing application performance using a finite state model and machine learning;

FIGS. 2A, 2B, 2C, 2D, 2E, and 2F depict an illustrative event sequence for optimizing application performance using a finite state model and machine learning in accordance with one or more example embodiments;

FIG. 3 depicts an example of a finite state model for optimizing application performance in accordance with one or more example embodiments;

FIG. 4 depicts an example graphical user interface for optimizing application performance using a finite state model and machine learning in accordance with one or more example embodiments; and

FIG. 5 depicts an illustrative method for optimizing application performance using a finite state model and machine learning in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to optimizing application performance in an infrastructure environment, which may be challenging because of dynamic changes in the environment that occur on a routine basis. Environments with logic resolution workflows may help to address sets of issues and keep a particular environment at an optimally configured level. However, it may be a challenge to characterize and identify a particular workflow as a static model for further configurations. In accordance with some aspects of the disclosure, a set of optimal specifications may be inferred from a dynamic analysis of outputs, observations, and/or records. Using information associated with a typical execution archetype of resolution techniques, a learned workflow may be filtered to optimally configure system parameters, reduce false positives, and/or model symbolic input to identify refined set point paths that are likely to represent ideal system conditions. To deal with variants, original rule sets may be identified from derived rule sets based on delta improvements. To systematically analyze a logic sequence of workflows, a system implementing one or more aspects of the disclosure may model all possible downstream interactions with systems and/or applications. In addition, the system may map all entry points to the system, various applications, and/or possible trails of execution, which may be validated and/or identified with the most optimal entry points.

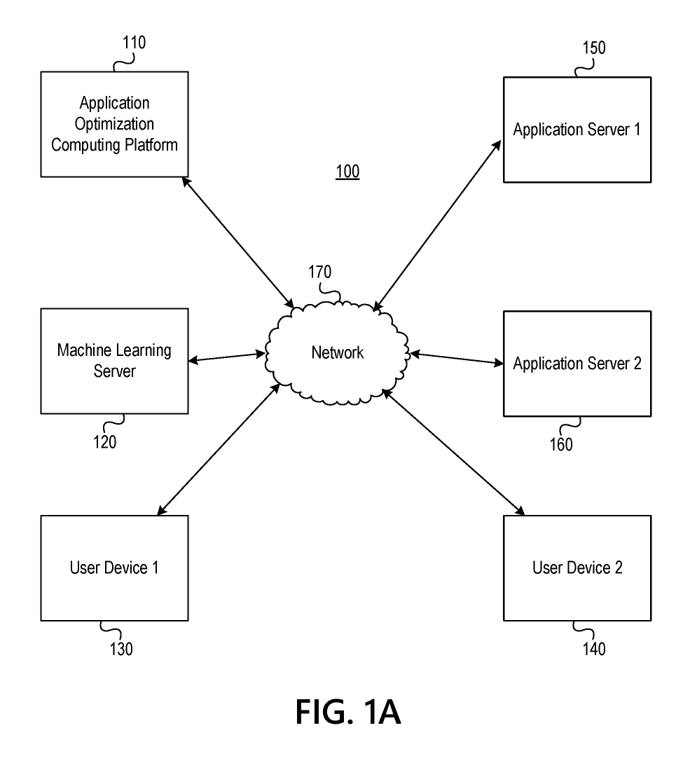

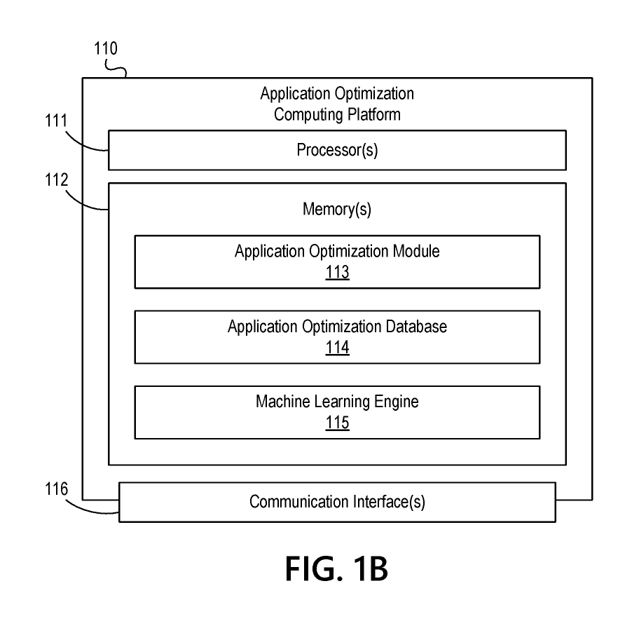

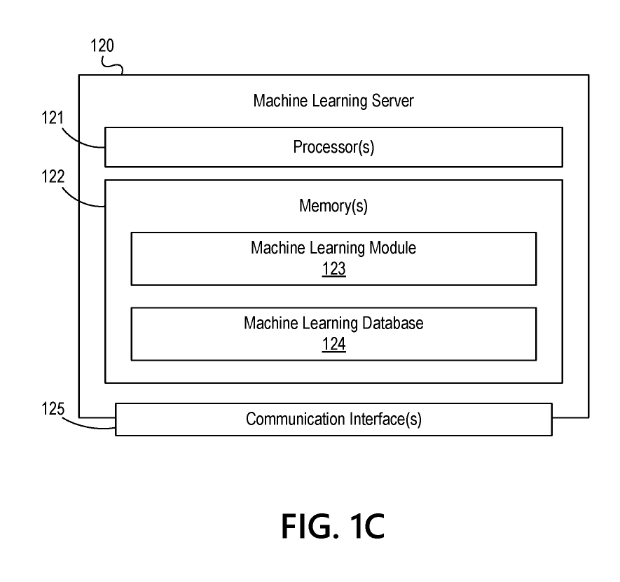

FIGS. 1A, 1B, and 1C depict an illustrative computing environment for optimizing application performance using a finite state model and machine learning in accordance with one or more example embodiments. Referring to FIG. 1A, computing environment 100 may include one or more computing devices and/or other computer systems. For example, computing environment 100 may include an application optimization computing platform 110, a machine learning server 120, a first user device 130, a second user device 140, a first application server 150, and a second application server 160.

Application optimization computing platform 110 may be configured to optimize application performance by controlling and/or directing actions of other devices and/or computer systems, and/or perform other functions, as discussed in greater detail below. In some instances, application optimization computing platform 110 may perform and/or provide one or more optimization techniques.

Machine learning server 120 may be configured to store and/or maintain machine learning data to optimize application performance. For example, machine learning server 120 may be configured to store and/or maintain information associated with finite states of an application or program, information associated with an amount of resources used to transition between different states, information associated with probabilities of transitioning to a certain state, and/or information associated with optimization techniques used to reduce the amount of resources used to transition between different states. Additionally, or alternatively, machine learning server 120 may be configured to receive machine learning data and/or one or more commands from the application optimization computing platform 110, send machine learning data to the application optimization computing platform 110, update machine learning data (e.g. based on machine learning data received from the application optimization computing platform 110), communicate by receiving and/or sending data with first user device 130, second user device 140, first application server 150, second application server 160 (e.g. based on one/or more commands from the application optimization computing platform 110), and/or perform other functions, as illustrated below. In some instances, the machine learning server 120 might not be another entity, but the functionalities of the machine learning server 120 may be included within the application optimization computing platform 110.

First user device 130 may be configured to be used by a first user of computing environment 100. For example, the first user device 130 may be configured to provide one or more user interfaces that enable the first user to use an application to perform a task associated with the application. The first user device 130 may receive, from the first user, user input or selections and send the user input or selections to the application optimization computing platform 110 and/or one or more other computer systems and/or devices in computing environment 100. The first user device 130 may receive, from the application optimization computing platform 110 and/or one or more other computer systems and/or devices in computing environment 100, information or data in response to the user input or selection.

Second user device 140 may be configured to be used by the first user or a second user of computing environment 100. For example, the second user device 140 may be configured to provide one or more user interfaces that enable the first user or the second user to use an application to perform a task associated with the application. The second user device 140 may receive, from the first user or the second user, user input or selections and send the user input or selections to the application optimization computing platform 110 and/or one or more other computer systems and/or devices in computing environment 100. The second user device 140 may receive, from the application optimization computing platform 110 and/or one or more other computer systems and/or devices in computing environment 100, information or data in response to the user input or selection.

First application server 150 may be a computing device configured to offer any desired service, and may run various languages and operating systems (e.g., servlets and java server pages (JSPs) running on Tomcat/MySQL, OSX, BSD, Ubuntu, Redhat, HTML5, JavaScript, AJAX, and COMET). For example, first application server 150 may store information to assist in transitioning between different states within the application. First application server 150 may provide one or more interfaces that allows communication with other systems (e.g., application optimization computing platform 110, machine learning server 120) in computing environment 100. In some instances, first application server 150 may receive, from application optimization computing platform 110 and/or machine learning server 120, requests for information; send, to application optimization computing platform 110 and/or machine learning server 120, requested information; receive, from application optimization computing platform 110 and/or machine learning server 120, commands; execute commands received from application optimization computing platform 110; and/or perform other functions, as discussed in greater detail below.

Second application server 160 may be a computing device configured to offer any desired service, and may run various languages and operating systems (e.g., servlets and JSPs running on Tomcat/MySQL, OSX, BSD, Ubuntu, Redhat, HTML5, JavaScript, AJAX, and COMET). For example, second application server 160 may store information to assist in transitioning between different states within the application. Second application server 160 may provide one or more interfaces that allows communications with other systems (e.g., application optimization computing platform 110, machine learning server 120) in computing environment 100. In some instances, second application server 160 may receive, from application optimization computing platform 110 and/or machine learning server 120, requests for information; send, to application optimization computing platform 110 and/or machine learning server 120, requested information; receive, from application optimization computing platform 110 and/or machine learning server 120, commands; execute commands received from application optimization computing platform 110; and/or perform other functions, as discussed in greater detail below

In one or more arrangements, machine learning server 120, first user device 130, second user device 140, first application server 150, and second application server 160 may be any type of computing device capable of providing a user interface, receiving input via the user interface, and communicating the received input to one or more other computing devices. For example, machine learning server 120, first user device 130, second user device 140, first application server 150, and second application server 160 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of machine learning server 120, first user device 130, second user device 140, first application server 150, and second application server 160 may, in some instances, be special-purpose computing devices configured to perform specific functions.

Computing environment 100 also may include one or more computing platforms. For example, and as noted above, computing environment 100 may include application optimization computing platform 110. As illustrated in greater detail below, application optimization computing platform 110 may include one or more computing devices configured to perform one or more of the functions described herein. For example, application optimization computing platform 110 may include one or more computers (e.g., laptop computers, desktop computers, servers, server blades, or the like).

Computing environment 100 also may include one or more networks, which may interconnect one or more of application optimization computing platform 110, machine learning server 120, first user device 130, second user device 140, first application server 150, and second application server 160. For example, computing environment 100 may include network 170. Network 170 may include one or more sub-networks (e.g., local area networks (LANs), wide area networks (WANs), or the like). For example, network 170 may include a private sub-network that may be associated with a particular organization (e.g., a corporation, financial institution, educational institution, governmental institution, or the like) and that may interconnect one or more computing devices associated with the organization. For example, application optimization computing platform 110, machine learning server 120, first user device 130, second user device 140, first application server 150, and second application server 160 may be associated with an organization, and a private sub-network included in network 170 and associated with and/or operated by the organization may include one or more networks (e.g., LANs, WANs, virtual private networks (VPNs), or the like) that interconnect application optimization computing platform 110, machine learning server 120, first user device 130, second user device 140, first application server 150, and second application server 160. Network 170 also may include a public sub-network that may connect the private sub-network and/or one or more computing devices connected thereto (e.g., application optimization computing platform 110, machine learning server 120, first user device 130, second user device 140, first application server 150, and second application server 160) with one or more networks and/or computing devices that are not associated with the organization.

Referring to FIG. 1B, application optimization computing platform 110 may include one or more processors 111, memory 112, and communication interface 116. A data bus may interconnect processor(s) 111, memory 112, and communication interface 116. Communication interface 116 may be a network interface configured to support communication between application optimization computing platform 110 and one or more networks (e.g., network 170). Memory 112 may include one or more program modules having instructions that when executed by processor(s) 111 cause application optimization computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of application optimization computing platform 110 and/or by different computing devices that may form and/or otherwise make up application optimization computing platform 110. For example, memory 112 may have, store, and/or include an application optimization module 113, an application optimization database 114, and a machine learning engine 115. Application optimization module 113 may have instructions that direct and/or cause application optimization computing platform 110 to optimize application performance and/or perform other functions, as discussed in greater detail below. Application optimization database 114 may store information used by application optimization module 113 and/or application optimization computing platform 110 in optimizing application performance and/or in performing other functions. Machine learning engine 115 may have instructions that direct and/or cause application optimization computing platform 110 to set, define, and/or iteratively redefine optimization rules, techniques and/or other parameters used by application optimization computing platform 110 and/or other systems in computing environment 100 in optimizing application performance using a finite state machine model and machine learning.

Referring to FIG. 1C, machine learning server 120 may include one or more processors 121, memory 122, and communication interface 125. Communication interface 125 may be a network interface configured to support communication between machine learning server 120 and one or more networks (e.g., network 170). Memory 122 may include one or more program modules having instructions that when executed by processor(s) 121 cause machine learning server 120 to optimize application performance and/or perform one or more other functions described herein and/or one or more databases that may store and/or otherwise maintain information which may be used by such program modules and/or processor(s) 121. In some instances, the one or more program modules and/or databases may be stored by and/or maintained in different memory units of machine learning server 120 and/or by different computing devices that may form and/or otherwise make up machine learning server 120. For example, machine learning server memory 122 may have, store, and/or include a machine learning module 123, and a machine learning database 124. Machine learning module 123 may have instructions that direct and/or cause machine learning server 120 to optimize application performance and/or perform other functions, as discussed in greater detail below. Machine learning database 124 may store information used by machine learning module 123 and/or machine learning server 120 in optimizing application performance and/or in performing other functions.

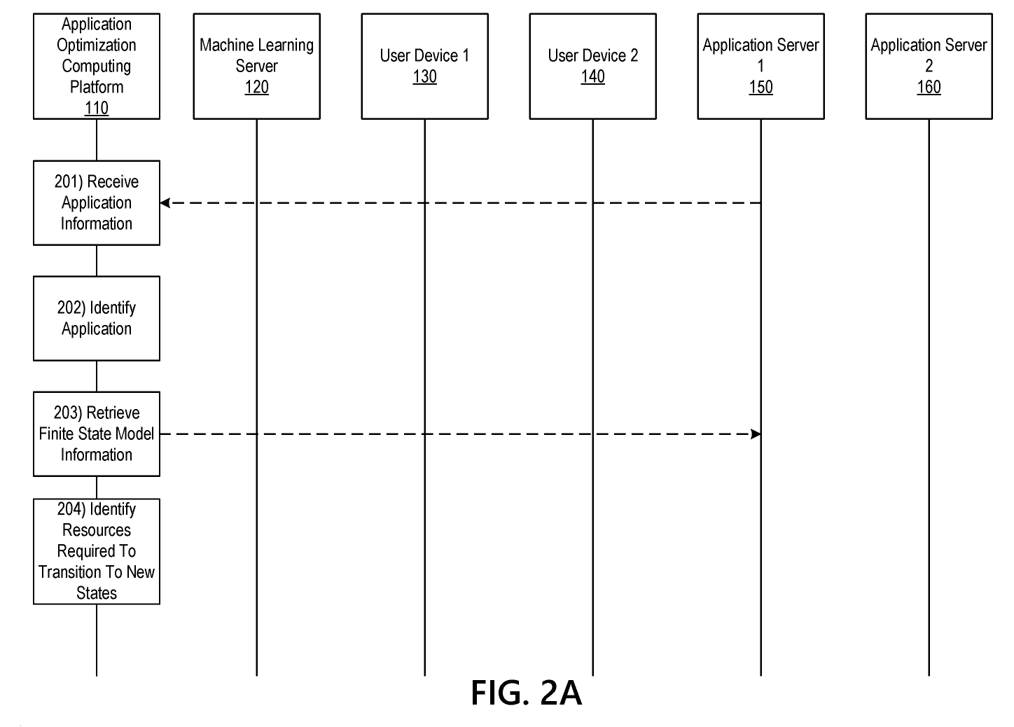

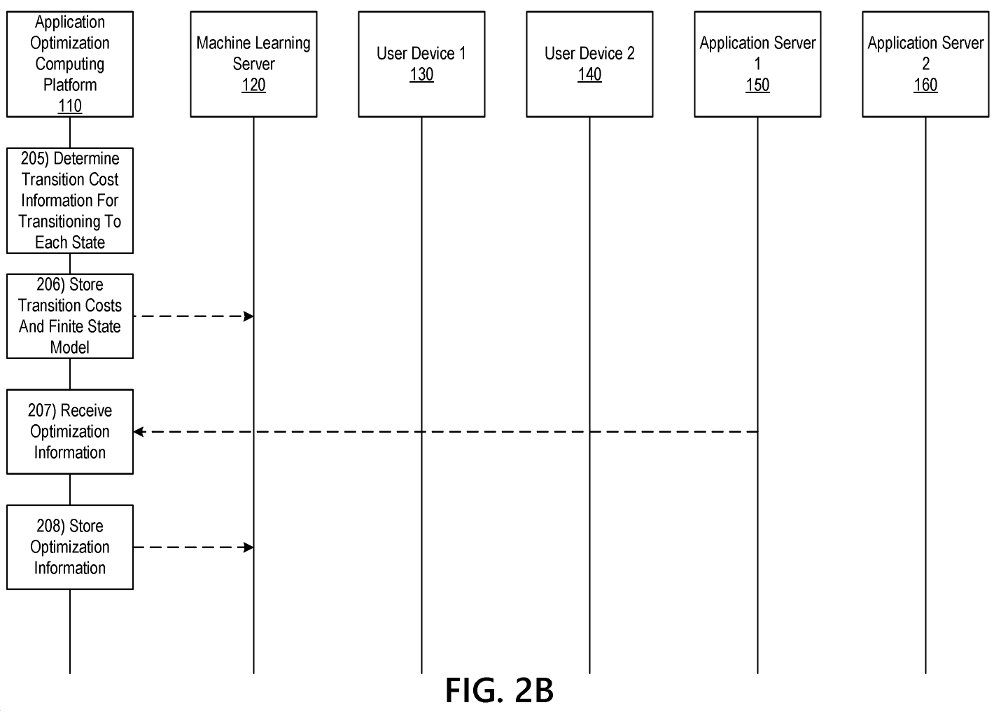

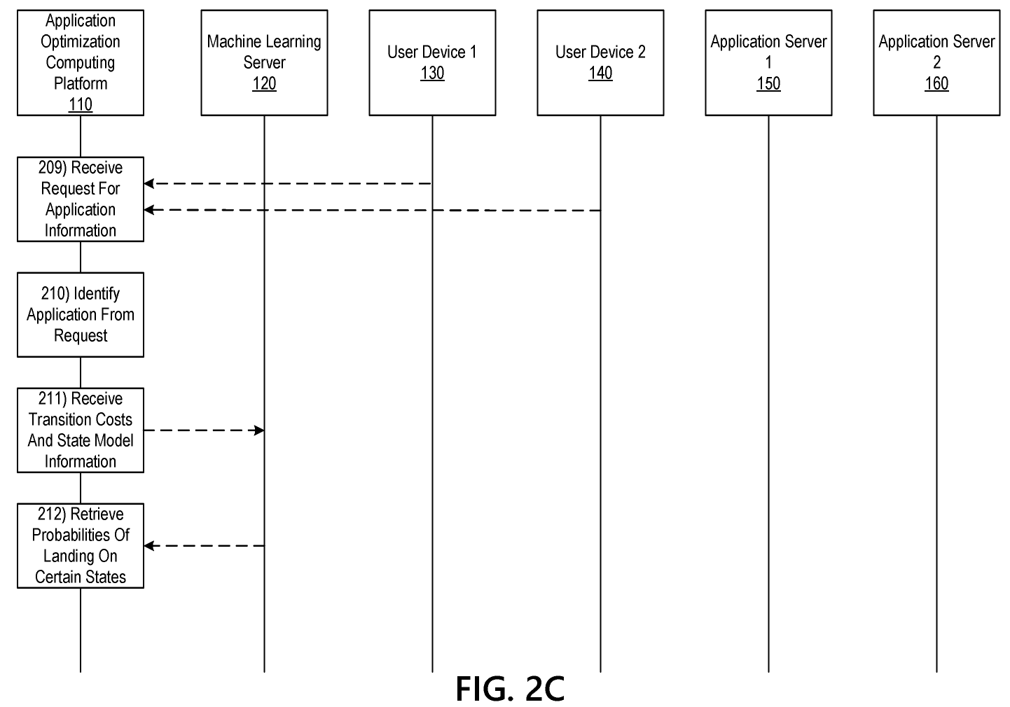

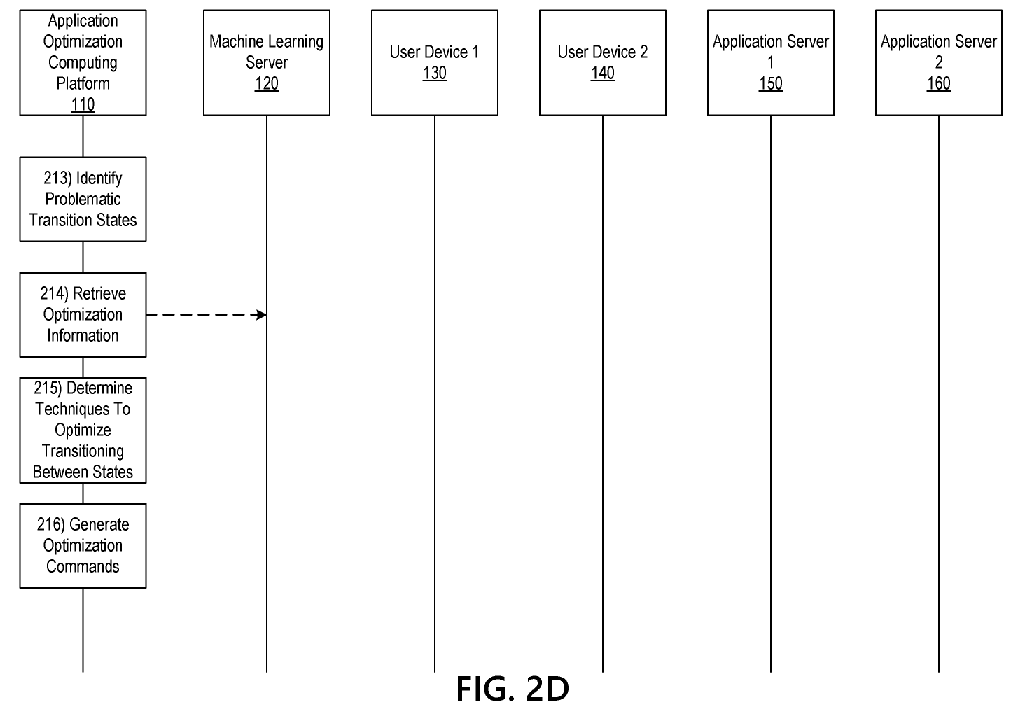

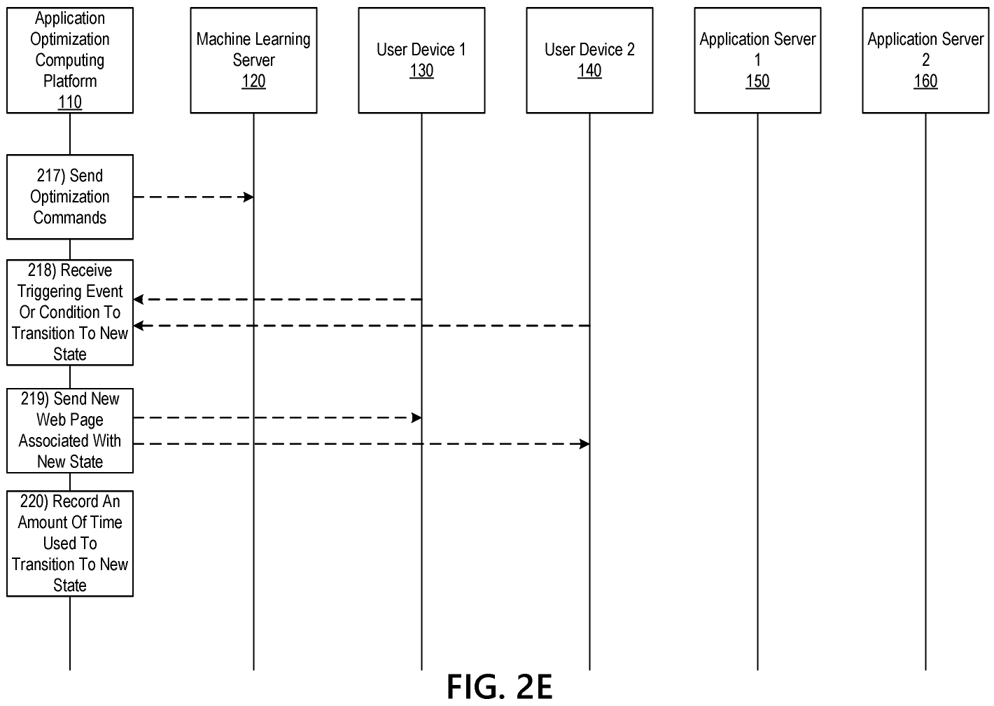

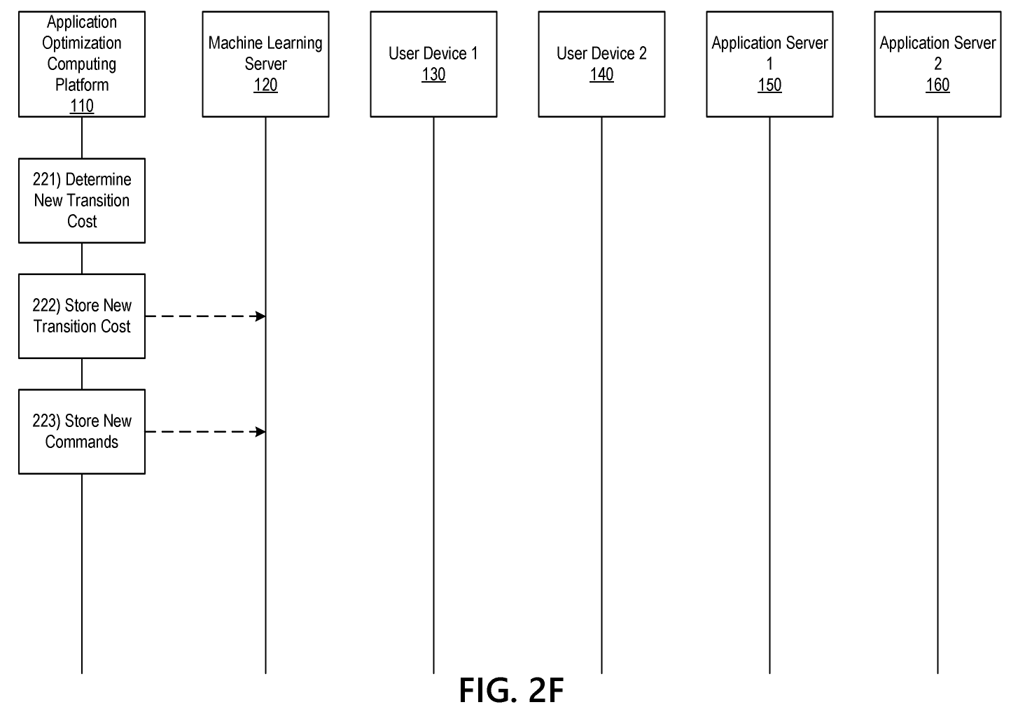

FIGS. 2A, 2B, 2C, 2D, 2E, and 2F depict an illustrative event sequence for optimizing application performance in accordance with one or more example embodiments. Referring to FIG. 2A, at step 201, application optimization computing platform 110 may receive application information. For example, at step 201, application optimization computing platform 110 may receive, via the communication interface (e.g., communication interface 116), from a server (e.g., first application server 150), information associated with an application. Application information may include one or more executable files, libraries, and/or other information associated with the application, and any and/or all of this information may permit the application optimization computing platform 110 to identify the application. A user may use the application to perform tasks, such as updating a user profile as shown in FIG. 4.

At step 202, application optimization computing platform 110 may identify the application. For example, at step 202, application optimization computing platform 110 may identify the application based on the received application information. The received application information may include application identifier information to distinguish between the multiple applications available to a user. Application optimization computing platform 110 may use the application identifier information to identify a particular application.

At step 203, application optimization computing platform 110 may retrieve finite state model information. For example, at step 203, application optimization computing platform 110 may retrieve finite state model information based on the identified application from step 202. The application optimization computing platform 110 may retrieve the finite state model information from the application optimization computing platform memory 112 or from an application server (e.g., first application server 150).

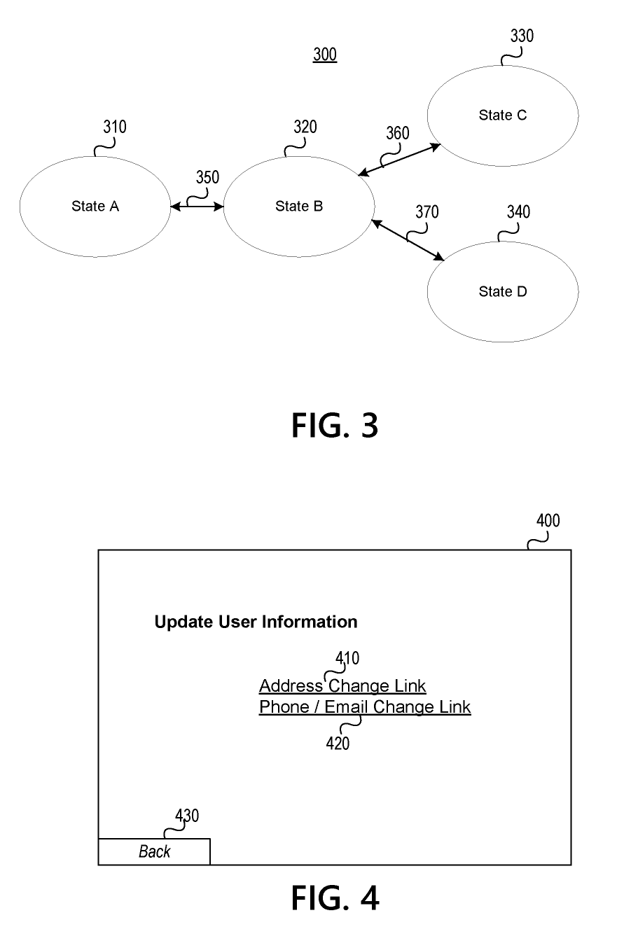

The finite state model information may include a finite state model defining multiple states of a particular application, similar to a finite state machine, which is illustrated in FIG. 3. As seen in FIG. 3, a finite state model 300 may include one or more states that may allow an application optimization computing platform 110 to define a status of the application. For example, State A 310, State B 320, State C 330, and State D 340 may represent different states (e.g., web pages) within the application. Each state or web page within the finite state model may be connected to one or more other states. For example, a first connector 350 may connect State A 310 and State B 320, a second connector 360 may connect State B 320 and State C 330, and a third connector 370 may connect State B 320 and State D 340.

The finite state model may transition from a current state to a new state upon receiving a triggering event or condition (e.g., a user selecting a link on a web page), which is illustrated in FIG. 4. As seen in FIG. 4, graphical user interface 400 may include one or more fields, controls, and/or other elements that may allow a user of a user device (e.g., first user device 130 or second user device 140) to interact with links associated with a current state (e.g., State B 320) of the finite state model. For example, graphical user interface 400 may allow a user to view the current state of the finite state model (e.g., “Update User Information”) and further view links (e.g., Address Change Link 410, Phone/Email Change Link 420, or Back Link 430) to a connected state (e.g., State A 310, State C 330, or State D 340). In addition, graphical user interface 400 may include one or more fields, controls, and/or other elements that may allow a user of a user device to select a link associated with a connected state. A triggering condition or event may occur when a user selects a link on graphical user interface 400, which may cause application optimization computing platform 110 to transition the finite state model from the current state (e.g., State B 320) to a new state (e.g., State C 330, State D 340, or State A 310) corresponding to the selected link. Transitioning to the new state may be completed once the new web page associated with the new state is fully loaded on the user device (e.g., first user device 130).

Referring back to FIG. 2A, at step 204, application optimization computing platform 110 may identify resources required to transition to new states. For example, at step 204, application optimization computing platform 110 may identify resources, such as an amount of data or information, required to transition from one state (e.g., State B 320) to another state (e.g., State C 330). Each state may require a different amount of resources to be retrieved from application servers prior to transitioning from the current state to the new state. For instance, a particular transition to a new state may require multiple images and/or data to be retrieved from the application servers. Application optimization computing platform 110 may, based on the finite state model, identify the required files or information to be loaded for each state of the finite state model and may further identify the locations (e.g. application servers) where the files or information are stored within network 170.

Referring to FIG. 2B, at step 205, application optimization computing platform 110 may determine transition cost information for transitioning to each state. For example, at step 205, application optimization computing platform 110 may determine transition cost information to transition from one state of the finite state model to a connected state of the finite state model based on the resources (e.g., identified from step 204) required to transition to the new, connected state. Referring back to FIG. 3, a connector (e.g., first connector 350, second connector 360, or third connector 370) may be associated with a transition cost for transitioning between states (e.g., State A 310 to State B 320, State B 320 to State C 330, or State B 320 to State D 340).

Transition costs to transition from the current state to the new state may be calculated and/or otherwise determined based on the amount of files required to be loaded for the new state and/or the number of service calls to application servers to retrieve the files for the new state. Application optimization computing platform 110 may perform a service call by sending, via the communication interface 116, one or more requests for information to one or more application servers (e.g., first application server 150 and/or second application server 160). After sending the request for information, application optimization computing platform 110 may receive the requested information from the application server.

In some instances, application optimization computing platform 110 may determine transition costs using a mathematical algorithm. For example, the amount of files or the number of service calls made to application servers may be weighted differently within the mathematical algorithm. In some embodiments, transition costs may be calculated based on an amount of time to load or transition from the current state to the new state. For example, application optimization computing platform 110 may determine, based on the amount of files and the number of service calls associated with each state of the finite state model, an amount of time to transition from a current state (e.g., current web page) to a new state (e.g., new web page). Application optimization computing platform 110 may, for instance, calculate a transition cost based on the amount of time to transition from the current state to the new state.

In some instances, multiple transition costs may be associated with a single state. For example, many states (e.g. State C 330 and State D 340), may transition or connect to the single state (e.g. State B). Further, a transition cost associated with transitioning between a first state (e.g. State B 320) to a second state (e.g. State C 330) might not be the same as transitioning from the second state (e.g. State C 330) to the first state (e.g. State B 320).

At step 206, application optimization computing platform 110 may store the transition cost information and the finite state model information. For example, at step 206, application optimization computing platform 110, after determining the transition costs corresponding with states of the finite state model, may store the transition cost information and the finite state model information within a server (e.g. machine learning server 120 or first application server 150). Application optimization computing platform 110 may send, via the communication interface 116, the transition cost information and the finite state model information to the server. After receiving the transition cost information and the finite state model information, the server (e.g. machine learning server 120) may store the information in memory (e.g. machine learning server memory 122). In some instances, rather than sending the information to a server, the application optimization computing platform 110 may store the transition cost information and the finite state model information in the application optimization computing platform memory 112.

At step 207, application optimization computing platform 110 may receive optimization information from a server. For example, at step 207, application optimization computing platform 110 may receive, via the communication interface 116, optimization information from a server (e.g., first application server 150 or machine learning server 120). In some instances, optimization information may be stored in the application optimization computing platform memory 112. Optimization information may define or include any techniques associated with reducing transition costs (e.g., reducing the amount of files to be loaded or reducing the amount of service calls to application servers, and/or other techniques or methods to reduce an amount of time required to transition to a new state within the finite state model).

In some instances, optimization information may include information defining a pre-fetching technique. For example, prior to receiving a triggering event or condition (e.g., transitioning from State B 320 to State C 330), application optimization computing platform 110 may pre-fetch information or data associated with the new state (e.g., State C 330). Using the pre-fetching technique, application optimization computing platform 110 may reduce the transition cost since necessary information or data to transition to the new state (e.g., State C 330) may have already been retrieved from the application servers. Once a triggering event or condition occurs, such as a user requesting a new web page, application optimization computing platform 110 may send the new web page to the user.

In some instances, optimization information may include information defining a pre-compilation technique. For example, prior to receiving a triggering event or condition (e.g., transitioning from State B 320 to State C 330), application optimization computing platform 110 may pre-compile the information or data associated with a state (e.g., State C 330) within the finite state model. Some states or web pages within the finite state model may use servlets or JSPs. Prior to transitioning to the new state (e.g., State C 330), application optimization computing platform 110 may need to compile the data or information associated with the new state. Prior to receiving the triggering event or condition, the application optimization computing platform 110 may retrieve, from an application server (e.g. first application server 150), data or information associated with the new state within the finite state model. After retrieving the data or information, the application optimization computing platform 110 may compile the data or information. Once a triggering event or condition occurs, such as a user requesting data associated with a new state, application optimization computing platform 110 may send the requested compiled data to the user device. Using the pre-compilation technique, application optimization computing platform 110 may reduce the transition costs because necessary information or files may be compiled prior receiving the request.

In some instances, optimization information may include information defining a probabilistic pre-fetch technique. For example, prior to receiving a triggering event or condition and prior to pre-fetching necessary information or data associated with a state, application optimization computing platform 110 may receive, via the communication interface 116, information specifying one or more probabilities or likelihoods of transitioning to states (e.g., a statistical probability of transitioning from State B 320 to State C 330 and/or a statistical probability of transitioning from State B 320 to State D 340) within the finite state model from a server (e.g. machine learning server 120 or first application server 150). Based on the statistical probabilities associated with states within a finite state model, application optimization computing platform 110 may pre-fetch necessary information or data associated with one or more states (e.g., State C 330 and/or State D 340) within the finite state model. For example, the statistical probability of transitioning to a first state (e.g., State C 330) may be higher than the statistical probability of transitioning to a second state (e.g., State D 340). Application optimization computing platform 110 may pre-fetch the first state (e.g., State C 330) because of the higher statistical probability of transitioning to the first state. In some instances, executing the probabilistic pre-fetch technique may be based on the statistical probabilities and the transition cost. For example, the statistical probability of transitioning to a first state (e.g., State C 330) may be higher than the statistical probability of transitioning to a second state (e.g., State D 340). However, the transition cost of the first state may be higher (e.g., require more resources to transition to the first state) than the transition cost of the second state. Application optimization computing platform 110 may pre-fetch the second state (e.g., State D 340), even though the statistical probability of transitioning to the second state is lower than the statistical probability of transitioning to the first state.

In some instances, probabilities of transitioning to a state within the finite state model may be used with any of the other optimization information techniques described herein. For example, based on the probabilities of landing on a state, application optimization computing platform 110 may perform a pre-compilation technique, a bundled or split service call technique, content compression technique and/or other techniques associated with lowering transition costs.

In some instances, optimization information may include information defining a bundled service call technique. For example, two or more states (e.g., State C 330 and State D 340) may require information located within a server (e.g., first application server 150). Application optimization computing platform 110 may receive a request from a user device (e.g., first user device 130) to transition to one of the states (e.g., State D 340). Application optimization computing platform 110 may use a bundled service call to retrieve information associated with State D 340, and may also retrieve information associated with State C 330 even if information associated with State C has not been requested. Once a triggering event or condition occurs, such as a user requesting data associated with State C 330, application optimization computing platform 110 may send the requested information to the user device. Using the bundled service call technique, application optimization computing platform 110 may reduce the transition costs because less service calls may be made after receiving the triggering event or condition. In some instances, the user device (e.g., first user device 130) requesting information about one of the states (e.g., State D 340) might not be the same user device (e.g., second user device 140) requesting information about the another state (e.g., State C 330).

In some instances, optimization information may include information defining a split service call technique. For example, a state within the finite state model (e.g., State B 320) may need information from two or more application servers (e.g. first application server 150 and second application server 160). Application optimization computing platform 110 may split the service call into two or more different service calls. One of the two or more service calls may be made prior to a triggering event or condition. The other service call may be made after the triggering event or condition. Using the split service call technique, application optimization computing platform 110 may reduce the transition costs because less service calls may be made after receiving the triggering event or condition. In some instances, a split service call and a bundled service call may be used in conjunction. For example, application optimization computing platform 110 may use a bundled service call to retrieve information associated with two or more states (e.g., State C 330 and State D 340) from one server (e.g. first application server 150). After receiving a triggering event or condition, application optimization computing platform 110 may use a split service call to retrieve information associated with one of the two states (e.g., State C) at another server (e.g. second application server 160).

In some instances, optimization information may include information defining a content compression technique. For example, application optimization computing platform 110 may use a content compression technique to compress files or data within a server (e.g., machine learning server 120, first application server 150, and/or second application server 160). The content compression technique may compress files, such that a file size may decrease in size and the file may be transmitted and received by the application optimization computing platform 110 faster. The compressed files may be transmitted through the network 170 to one or more other computer systems and/or devices in computing environment 100. In some instances, application optimization computing platform 110 may retrieve information from one or more servers (e.g., first application server 150), compress the file, and send the compressed file to one or more computing systems and/or devices in computing environment 100. In some embodiments, application optimization computing platform 110 may generate one or more commands to compress files stored within an application server. After receiving the one or more commands, an application server may execute the one or more commands and compress the files.

In some instances, optimization information may include information defining an image sprite technique. For example, one or more states within the finite state model may include multiple images. Application optimization computing platform 110 may retrieve the multiple images and combine them into one image. In some instances, multiple images may be stored in one or more locations or servers (e.g., first application server 150 and/or second application server 160). Application optimization computing platform 110 may retrieve the multiple images and combine the multiple images into one combined image. Application optimization computing platform 110 may store the combined image in a server (e.g., machine learning server 120 and/or first application server 150). Upon transitioning to a new state requiring the combined image, application optimization computing platform 110 may retrieve the combined image from the server. In some instances, the application optimization computing platform 110 may store the combined image within the application optimization computing platform memory 112. In some embodiments, the application optimization computing platform 110 might not combine the multiple images into one combined image. Rather, the application optimization computing platform 110 may store the multiple images into one storage server, such as first application server 150, and reduce the amount of service calls required to retrieve the multiple images.

In some instances, optimization information may include information defining a hardware event triggered optimization technique. For example, application optimization computing platform 110 may receive, via the communication interface, and from a user device (e.g., first user device 130), hardware specifications associated with the user device. The hardware specifications may include an amount of computing power associated with the user device. The amount of computing power may be related to the speed a user device loads a web page or application. Application optimization computing platform 110 may determine multiple priorities associated with the new web page (e.g., State C 330) when transitioning between a current web page (e.g., State B 320) to a new web page (e.g., State C 330). Based on the hardware specifications, application optimization computing platform 110 may determine percentages of the amount of computing power to allocate to the multiple priorities. Application optimization computing platform 110 may send, via the communication interface 116, information associated with the percentages of the amount of computing power to allocate to the multiple priorities to the user device (e.g., first user device 130).

In some instances, optimization information may include information based on the identified application and the finite state model. For example, based on transitioning from between states within an identified application (e.g., transitioning from State A 310 to State B 320 and/or transitioning from State B 320 to State C 330) optimization information may include information about executing one or more techniques (e.g., pre-fetch technique, pre-compilation technique, probabilistic pre-fetch technique, bundled service call technique, split service call technique, content compression technique, image sprite technique, and/or hardware optimization technique) to optimize the transition costs. For example, and as will be explained in further detail below, when one or more techniques is used to transition from a first state to a second state, information associated with using the one or more techniques and/or updated transition costs may be recorded and stored. Updated transition costs may be a new transition cost associated with transitioning from the first state to the second state based on using the one or more techniques to optimize the transition cost. In some instances, since one or more techniques may be used to optimize the transition cost, the updated transition cost may be lower (e.g., reduce the amount of files to be loaded and/or reduce the amount of service calls to be made to application servers) than the determined transition cost in step 205.

At step 208, application optimization computing platform 110 may store the optimization information. For example, at step 208, application optimization computing platform 110 may store the optimization information within a server (e.g. machine learning server 120 or first application server 150). Application optimization computing platform 110 may send, via the communication interface 116, the optimization information to the server. After receiving the optimization information, the server (e.g. machine learning server 120) may store the optimization information in memory (e.g. machine learning server memory 122). In some instances, application optimization computing platform 110 may store the optimization information in the application optimization computing platform memory 112.

Referring to FIG. 2C, at step 209, application optimization computing platform 110 may receive a request for application information from a user device. For example, at step 209, application optimization computing platform 110 may receive, via the communication interface (e.g., communication interface 116), from the user device (e.g., first user device 130 or second user device 140), one or more requests for application information. The one or more requests for application information may, for instance, be a request for any information related to an application the first user device is operating. The request for application information may include any information that permits the application optimization computing platform 110 to identify the application from among a plurality of different software applications that may be executed on one or more computer systems associated with an organization operating application optimization computing platform 110, including task identification information, current web page information, and/or new web page information. Additionally, the request for application information may include information about a user's credentials to assist the application optimization computing platform 110 in identifying a user.

In some instances, application optimization computing platform 110 may receive a request for application information when the first user device 130 starts the application. In some instances, application optimization computing platform 110 may receive a request for application information when the first user device 130 attempts to transition from a current web page (e.g., a first state, such as State A 310) to a new web page (e.g., a second state, such as State B 320).

At step 210, application optimization computing platform 110 may identify an application. For example, at step 210, application optimization computing platform 110 may identify the application based on the received request for application information from step 209. In identifying the application associated with the request for application information, application optimization computing platform 110 may, for instance, identify an application running on the first user device 130. In some examples, application optimization computing platform 110 may determine a task to be performed on the first user device 130 based on the received request for application information from step 209 (e.g., from the task identification information). In some instances, the request for application information may include application identifier information. The application identifier information may include information that identifies the application running on the user device.

At step 211, application optimization computing platform 110 may retrieve the transition costs and finite state model information. For example, at step 211, application optimization computing platform 110 may retrieve, via the communication interface (e.g., communication interface 116), from a server (e.g., machine learning server 120 and stored in step 206), transition costs and finite state model information associated with the identified application and/or the identified task information. For example, after identifying the application and/or task from step 210, application optimization computing platform 110 may send a request for information requesting the application's transition costs and finite state model to a server (e.g. machine learning server 120) where the transition cost information and the finite state model information are stored (e.g. machine learning server 120) from step 206. The server (e.g. machine learning server 120) may send information associated with the application's transition costs and the finite state model to the application optimization computing platform 110.

At step 212, application optimization computing platform 110 may receive probabilities of transitioning between states within the finite state model. For example, at step 212, application optimization computing platform 110 may receive the statistical probabilities of transitioning between states within the finite state model from a server (e.g. machine learning server 120 or first application server 150). Statistical probabilities of transitioning to a state may be the likelihood of transitioning from one state within the finite state model to another state, which is described in further detail above.

In some instances, application optimization computing platform 110 may store statistical probabilities within the application optimization computing platform memory 112. For example, transitions between certain states within the finite state model (e.g., transitioning between State B 320 to State C 330) may be more frequently or more recently used than transitions between other states (e.g., transitioning between State B 320 to State D 340). Application optimization computing platform 110 may store statistical probabilities corresponding to the more frequently or more recently used transitions between states within the application optimization computing platform memory 112. At step 212, application optimization computing platform 110 may retrieve probabilities of transitioning between states within the finite state model from the application optimization computing platform memory 112.

Referring to FIG. 2D, at step 213, application optimization computing platform 110 may identify problematic transition states. For example, at step 213, application optimization computing platform 110 may identify problematic transition states based on the retrieved transition costs from step 211. In some instances, application optimization computing platform 110 may identify states that have high transition costs (e.g., a state requiring a large amount of resources to transition or load the state) as problematic transition states.

In some instances, application optimization computing platform 110 may send, via the communication interface 116, information associated with identified problematic transition states to a user device (e.g. first user device 130). The user device may determine techniques to lower the transition costs for these identified problematic transition states and send information corresponding to the techniques to lower the transition costs back to the application optimization computing platform 110.

In some instances, problematic transition states may be identified based on a threshold value. For example, application optimization computing platform 110 may receive, via the communication interface 116, a threshold value from a user device (e.g. first user device 130). States within the finite state model with higher transition costs than the threshold value may be identified by the application optimization computing platform 110 as problematic transition states.

In some instances, problematic transition states may be identified based on probabilities and transition cost associated with transitioning between states. For example, application optimization computing platform 110 may identify a problematic transition state as a state with a high statistical probability of being transitioned to and a low transition cost. In some embodiments, application optimization computing platform 110 may identify a problematic transition state as a state with a low statistical probability of being transitioned to and a high transition cost.

At step 214, application optimization computing platform 110 may retrieve the optimization information. For example, at step 214, application optimization computing platform 110 may retrieve, via the communication interface (e.g., communication interface 116), from a server optimization information associated with techniques to lower transition costs (e.g., step 208). For example, application optimization computing platform 110 may send a request for information requesting the application's optimization information to a server (e.g. machine learning server 120) where the optimization information is stored (e.g. machine learning server 120). The server (e.g. machine learning server 120) may send information associated with the optimization information to the application optimization computing platform 110. In some instances, information associated with optimization information may be stored in the application optimization computing platform memory 112. Application optimization computing platform 110 may retrieve the information associated with the optimization information from the application optimization computing platform memory 112.

At step 215, application optimization computing platform 110 may determine techniques to optimize transitioning between states. For example, at step 215, application optimization computing platform 110 may determine techniques to optimize transitioning between states based on transition costs, problematic transition states, optimization information, finite state model and/or other factors or attributes associated with states within the finite state model.

In some instances, application optimization computing platform 110 may determine states to use one or more of the techniques defined in the optimization information based on the identified problematic transition states in step 213. Such techniques in the optimization information may include a pre-fetching technique, a pre-compilation technique, a probabilistic pre-fetch technique, a bundled or split service call technique, a content compression technique, an image sprite technique, and/or hardware event triggered optimization technique.

In some instances, application optimization computing platform 110 may determine techniques based on factors or attributes associated with transitioning to the state (e.g. web page). For example, a state may require multiple service calls to different servers (e.g. first application server 150 or second application server 160) prior to transitioning to the state. Application optimization computing platform 110 may use a bundled or split service call technique based on the required multiple service calls to different servers. In some examples, a state may need compilation of the web page prior to transitioning to the state. Application optimization computing platform 110 may use a pre-compilation technique based on the need to compile the web page prior to loading the state. In some instances, there may be a high statistical probability of transitioning from a current state to a new state. Application optimization computing platform 110 may use a probabilistic pre-fetch technique based on the high statistical probability of transitioning from the current state to the new state.

In some embodiments, application optimization computing platform 110 may determine techniques to optimize transitioning between states based on past, record experiences of using the one or more techniques to transition between the states. For example, as described above, optimization information may include information associated with previous experiences of using one or more techniques to transition between states. The optimization information may include an updated transition cost. By comparing the updated transition cost and the transition cost determined in step 205, the application optimization computing platform 110 may use the one or more techniques again, may use one or more new techniques, and/or may use the one or more techniques in conjunction with one or more new techniques. For example, if the updated transition cost is lower than the transition cost determined in step 205, the application optimization computing platform 110 may use the one or more techniques again and/or may use the one or more techniques in conjunction with one or more new techniques. In some examples, if the updated transition cost is about even with the transition cost determined in step 205, application optimization computing platform 110 may use one or more new techniques, and/or may use the one or more techniques in conjunction with one or more new techniques. In some instances, if the updated transition cost is higher than the transition cost determined in step 205, application optimization computing platform 110 may use one or more new techniques to optimize the transition costs.

At step 216, application optimization computing platform 110 may generate one or more commands to execute the one or more techniques. For example, at step 216, application optimization computing platform 110 may generate commands directing a server (e.g., machine learning server 120) to execute one or more techniques based on the one or more techniques determined in step 215.

Referring to FIG. 2E, at step 217, application optimization computing platform 110 may send the one or more commands to a server. For example, at step 217, after generating the one or more commands, application optimization computing platform 110 may send, via the communication interface 116, the one or more commands to a server (e.g. machine learning server 120) for the server to execute the command. In sending one or more commands to machine learning server 120, application optimization computing platform 110 may direct, control, and/or otherwise cause machine learning server 120 to execute the one or more techniques to optimize the transition cost.

At step 218, application optimization computing platform 110 may receive a triggering event or condition to transition to a new state. For example, at step 218, application optimization computing platform 110 may receive, via the communication interface 116, a triggering event or condition (e.g. a request to transition to a new web page) from a user device (e.g. first user device 130 or second user device 140). After receiving the triggering event or condition, application optimization computing platform 110 may transition between a current state (e.g., current web page) to a new state (e.g., new web page) within the finite state model. The new state may require an amount of resources (e.g., data to be loaded and/or service calls to be made) to be loaded prior to transitioning to the new state.

In some examples, the one or more techniques to be executed by the machine learning server 120 may be executed prior to receiving the triggering event or condition (e.g., step 217 occurs before step 218). For example, a pre-fetch technique, a pre-compilation technique, a probabilistic pre-fetch technique, a bundled/split service call technique, a content compression technique, an image sprite technique and/or a hardware event triggered optimization technique may be executed prior to receiving the triggering event or condition. In some embodiments, the one or more techniques sent to the server may be executed by the machine learning server 120 after receiving the triggering event or condition (e.g., step 218 occurs before step 217).

At step 219, application optimization computing platform 110 may send a new web page to a user device. For example, at step 219, application optimization computing platform 110 may send, via the communication interface 116, information associated with the new state (e.g., new web page) to a user device (e.g. first user device 130 or second user device 140). After receiving the triggering event or condition to transition to a new state and executing the one or more techniques to optimize the transition cost, application optimization computing platform 110 may send, via the communication interface 116, the information associated with the new web page to the user device. In some instances, the machine learning server 120, rather than the application optimization computing platform 110, in executing the one or more generated commands, may retrieve the requested information associated with the new web page and send information associated with the new web page to the user device.

At step 220, application optimization computing platform 110 may record an amount of time to transition from a current state to a new state. For example, at step 220, application optimization computing platform 110 may record a time used between receiving a triggering event or condition from the user device and sending the requested web page to the user device. Application optimization computing platform 110 may begin recording the time when a triggering event or condition is received. Application optimization computing platform 110 may finish recording the time when the requested web page is sent to the user device. The amount of time to transition from the current state to the new state may be stored in a server (e.g. machine learning server 120) or may be stored in the application optimization computing platform memory 112.

Referring to FIG. 2F, at step 221, application optimization computing platform 110 may determine new transition costs. For example, at step 221, application optimization computing platform 110 may determine a new or updated transition cost based on the amount of time to transition from the current state to the new state and based on the determined transition costs in step 205. As explained above, the one or more techniques used to optimize transition costs may reduce the amount of time required to transition between a current state (e.g., current web page) to a new state (e.g., new web page). Based on the amount of time and the current transition cost (e.g., determined in step 205), a new transition cost may be determined. In some examples, the new transition cost may be lower (e.g., using the one or more techniques to reduce amount of information to be loaded and/or reduce amount of service calls to application servers) than the transition cost from step 205.

At step 222, application optimization computing platform 110 may store the new transition costs. For example, at step 222, application optimization computing platform 110, after determining the new transition costs, may store the new transition cost information within a server (e.g., machine learning server 120 or first application server 150). Application optimization computing platform 110 may send, via the communication interface 116, the new transition cost information to the server. After receiving the new transition cost information, the server (e.g., machine learning server 120) may store the new transition cost information in memory (e.g., machine learning server memory 122). In some instances, rather than sending the new transition cost information to a server, the application optimization computing platform 110 may store the new transition cost information in the application optimization computing platform memory 112.

In some instances, as described above, optimization information may include updated transition cost information. Application optimization computing platform 110 may associate the new transition cost information with the optimization information. Thus, in another iteration of this process, and in step 215, application optimization computing platform 110 may use the new transition cost to determine the one or more techniques to optimize the transition costs.

At step 223, application optimization computing platform 110 may store the new techniques to optimize transitioning between states. For example, at step 223, application optimization computing platform 110, after determining the one or more techniques to optimize transitioning between states in step 215, may store information associated with the new one or more techniques within a server (e.g., machine learning server 120 or first application server 150). Application optimization computing platform 110 may send, via the communication interface 116, the information associated with the new optimization commands to the server. After receiving the information, the server (e.g. machine learning server 120) may store the information in memory (e.g. machine learning server memory 122). In some instances, rather than sending the information to a server, the application optimization computing platform 110 may store information in the application optimization computing platform memory 112.

In some instances, as described above, optimization information may include using the one or more techniques to optimize the transition costs. Application optimization computing platform 110 may associate the determined new one or more techniques from step 215 with the optimization information. Thus, in another iteration of this process, and in step 215, application optimization computing platform 110 may use the new determined one or more techniques to determine the one or more techniques to optimize the transition costs.

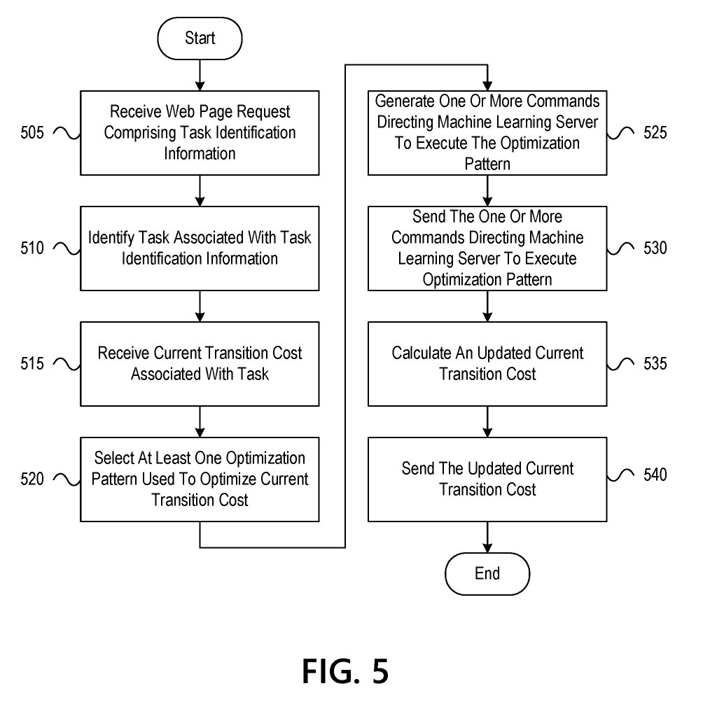

FIG. 5 depicts an illustrative method for optimization application performance using a finite state model and machine learning. Referring to FIG. 5, at step 505, a computing platform having at least one processor, a memory, and a communication interface may receive, via the communication interface, from first user device, a web page request comprising task identification information. At step 510, the computing platform may identify a task associated with the task identification information. At step 515, the computing platform may receive, via the communication interface, from machine learning server 120, a current transition cost associated with the task. At step 520, the computing platform may select at least one optimization pattern used to optimize the current transition cost. At step 525, the computing platform may generate one or more commands directing the machine learning server to execute the optimization pattern. At step 530, the computing platform may send, via the communication interface, to the machine learning server, the one or more commands directing the machine learning server to execute the optimization pattern. At step 535, the computing platform may calculate an updated current transition cost. At step 540, the computing platform may send, via the communication interface, to the machine learning server, the updated current transition cost.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive, via the communication interface, from a first user device, a web page request comprising current web page identification information, new web page identification information, and task identification information;
identify a task associated with the task identification information;
receive, from a machine learning server, a current transition cost associated with the task, the current transition cost corresponding to an amount of resources used in transitioning between a current web page associated with the current web page identification information to a new web page associated with the new web page identification information;
select, based on the task and the current transition cost, at least one optimization pattern used to optimize the current transition cost;
responsive to selecting the at least one optimization pattern, generate one or more commands directing the machine learning server to execute the at least one optimization pattern;
send, via the communication interface and to the machine learning server, the one or more commands directing the machine learning server to execute the at least one optimization pattern;
calculate, based on a time for the first user device to transition between the current web page to the new web page using the at least one optimization pattern executed by the machine learning server, an updated current transition cost; and
send, via the communication interface and to the machine learning server, the updated current transition cost.

2. The computing platform of claim 1, wherein the memory stores additional computer-readable instructions that, when executed by the at least one processor, cause the computing platform to:
determine, based on the task, a first web page associated with a first link from the new web page and a second web page associated with a second link from the new web page;
receive, from the machine learning server, a first transition cost associated with an amount of resources used in transitioning between the new web page to the first web page;
select, based on the task and the first transition cost, at least one optimization pattern used to optimize the first transition cost;
responsive to selecting the at least one optimization pattern used to optimize the first transition cost, generate one or more commands directing the machine learning server to execute the at least one optimization pattern used to optimize the first transition cost;
send, via the communication interface and to the machine learning server, the one or more commands directing the machine learning server to execute the at least one optimization pattern used to optimize the first transition cost;
calculate, based on a first time for the first user device to transition between the new web page to the first web page using the at least one optimization pattern executed at the machine learning server, an updated first transition cost; and
send, via the communication interface and to the machine learning server, the updated first transition cost.

3. The computing platform of claim 2, wherein generating one or more commands directing the machine learning server to execute the at least one optimization pattern used to optimize the first transition cost comprises:
retrieving, from an application server and using a pre-fetch command, data associated with the first web page;
after retrieving the data associated with first web page, receiving, from the first user device, a first web page request comprising a request for data associated with the first web page; and
sending, to the first user device, the data associated with the first web page.

4. The computing platform of claim 3, wherein the memory stores additional computer-readable instructions that, when executed by the at least one processor, cause the computing platform to:
receive, from the machine learning server, a probability corresponding to a statistical probability of receiving the first web page request; and
wherein generating one or more commands directing the machine learning server to execute the at least one optimization pattern used to optimize the first transition cost is based on the probability.

5. The computing platform of claim 2, wherein generating one or more commands directing the machine learning server to execute the at least one optimization pattern used to optimize the first transition cost comprises:
retrieving, from an application server, data associated with the first web page;
compiling, using a pre-compilation command, the data associated with the first web page;
after compiling the data associated with the first web page, receiving, from the first user device, a first web page request comprising a request for compiled data associated with the first web page; and
sending, to the first user device, the compiled data associated with the first web page.

6. The computing platform of claim 2, wherein the memory stores additional computer-readable instructions that, when executed by the at least one processor, cause the computing platform to:
determine, based on the first web page and the second web page, a first application server where first data associated with the first web page and data associated with the second web page are stored and a second application server where second data associated with the first web page is stored; and
wherein generating one or more commands directing the machine learning server to execute the at least one optimization pattern used to optimize the first transition cost comprises:
receiving a second web page request associated with the second web page;
after receiving the second web page request, retrieving, from the first application server and using a bundled service call command, the first data associated with the first web page and the data associated with the second web page;
after retrieving the first data associated with the first web page, receiving, from the first user device, a first web page request comprising a request for data associated with the first web page; and
sending, to the first user device, the first data associated with the first web page.

7. The computing platform of claim 6, wherein generating one or more commands directing the machine learning server to execute the at least one optimization pattern used to optimize the first transition cost further comprises:
after receiving the first web page request, retrieving, from the second application server and using a split service call command, the second data associated with the first web page; and
sending, to the first user device, the second data associated with the first web page.

8. The computing platform of claim 1, wherein the memory stores additional computer-readable instructions that, when executed by the at least one processor, cause the computing platform to:
generate a command directing an application server to compress data associated with the new web page using a content compression command to produce compressed data;
send, to the application server, the command; and
wherein generating one or more commands directing the machine learning server to execute the at least one optimization pattern used to optimize the current transition cost comprises:
retrieving, from the application server, the compressed data associated with the new web page;
after retrieving the compressed data, receiving, from the first user device, a new web page request comprising a request for the data associated with the new web page; and
transmitting, to the first user device, the compressed data associated with the new web page.

9. The computing platform of claim 1, wherein the memory stores additional computer-readable instructions that, when executed by the at least one processor, cause the computing platform to:
determine, based on the new web page, a first application server where a first image associated with the new web page is stored and a second application server where a second image associated with the new web page is stored; and
wherein generating one or more commands directing the machine learning server to execute the at least one optimization pattern used to optimize the current transition cost comprises:
retrieving, from the first application server and the second application server, the first image and the second image;
combining the first image and the second image into a combined image;
after combining the first image and the second image, receiving, from the first user device, a new web page request comprising a request for the first image and the second image; and
transmitting, to the first user device, the combined image.

10. The computing platform of claim 1, wherein the memory stores additional computer-readable instructions that, when executed by the at least one processor, cause the computing platform to:
receive, from the first user device, hardware specifications comprising an amount of computing power associated with the first user device; and
wherein generating one or more commands directing the machine learning server to execute the at least one optimization pattern used to optimize the current transition cost comprises:
determining, based on the new web page, a first priority associated with the new web page and a second priority associated with the new web page;
determining, based on the first priority, the second priority, and the hardware specifications, a first percentage of computing power to perform the first priority and a second percentage of computing power to perform the second priority; and
transmitting, to the first user device, the first percentage of computing power and the second percentage of computing power.

11. The computing platform of claim 2, wherein the memory stores additional computer-readable instructions that, when executed by the at least one processor, cause the computing platform to:
receive, via the communication interface, from a second user device, a second user web page request comprising second task identification information;
identify, by comparing the task identification information received from the first user device and the second task identification information from the second user device, the task;
receive, from the machine learning server, the updated current transition cost;
select, based on the task and the updated current transition cost, at least one optimization pattern used to optimize the updated current transition cost;
responsive to selecting the at least one optimization pattern, generate one or more commands directing the machine learning server to execute the at least one optimization pattern to optimize the updated current transition cost;
send, via the communication interface and to the machine learning server, the one or more commands directing the machine learning server to execute the at least one optimization pattern to optimize the updated current transition cost;
calculate, based on a second time for the second user device to transition between the current web page to the new web page using the at least one optimization pattern executed at the machine learning server, a second updated current transition cost; and
send, via the communication interface and to the machine learning server, the second updated current transition cost.

12. The computing platform of claim 11, wherein the memory stores additional computer-readable instructions that, when executed by the at least one processor, cause the computing platform to:
receive, from the machine learning server, the updated first transition cost;
select, based on the task and the updated first transition cost, at least one optimization pattern used to optimize the updated first transition cost;
responsive to selecting the at least one optimization pattern used to optimize the updated first transition cost, generate one or more commands directing the machine learning server to execute the at least one optimization pattern used to optimize the updated first transition cost;
send, via the communication interface and to the machine learning server, the one or more commands directing the machine learning server to execute the at least one optimization pattern used to optimize the updated first transition cost;
calculate, based on a third time for the second user device to transition between the new web page to the first web page using the at least one optimization pattern executed at the machine learning server, a second updated first transition cost; and
send, via the communication interface and to the machine learning server, the second updated first transition cost.

13. The computing platform of claim 12, wherein generating one or more commands directing the machine learning server to execute the at least one optimization pattern used to optimize the updated first transition cost comprises:
retrieving, from an application server and using a pre-fetch command, data associated with the first web page;
after retrieving the data associated with first web page, receiving, from the second user device, a first web page request comprising a request for data associated with the first web page; and
sending, to the second user device, the data associated with the first web page.

14. The computing platform of claim 13, wherein the memory stores additional computer-readable instructions that, when executed by the at least one processor, cause the computing platform to:
receive, from the machine learning server, a probability corresponding to a statistical probability of receiving the first web page request; and
wherein generating one or more commands directing the machine learning server to execute the at least one optimization pattern used to optimize the updated first transition cost is based on the probability.

15. The computing platform of claim 12, wherein generating one or more commands directing the machine learning server to execute the at least one optimization pattern used to optimize the updated first transition cost comprises:
retrieving, from an application server, data associated with the first web page;
compiling, using a pre-compilation command, the data associated with the first web page;
after compiling the data associated with the first web page, receiving, from the second user device, a first web page request comprising a request for compiled data associated with the first web page; and
sending, to the second user device, the compiled data associated with the first web page.

16. The computing platform of claim 12, wherein the memory stores additional computer-readable instructions that, when executed by the at least one processor, cause the computing platform to:
determine, based on the first web page and the second web page, a first application server where first data associated with the first web page and data associated with the second web page are stored and a second application server where second data associated with the first web page is stored; and
wherein generating one or more commands directing the machine learning server to execute the at least one optimization pattern used to optimize the updated first transition cost comprises:
receiving a second web page request associated with the second web page;
after receiving the second web page request, retrieving, from the first application server and using a bundled service call command, the first data associated with the first web page and the data associated with the second web page;
after retrieving the first data associated with the first web page, receiving, from the second user device, a first web page request comprising a request for data associated with the first web page; and
sending, to the second user device, the first data associated with the first web page.

17. The computing platform of claim 16, wherein generating one or more commands directing the machine learning server to execute the at least one optimization pattern used to optimize the updated first transition cost further comprises:
after receiving the first web page request, retrieving, from the second application server and using a split service call command, the second data associated with the first web page; and
sending, to the second user device, the second data associated with the first web page.

18. A method, comprising:
at a computing platform comprising at least one processor, memory, and a communication interface:
receiving, via the communication interface, by the at least one processor, and from a first user device, a web page request comprising current web page identification information, new web page identification information, and task identification information;
identifying, by the at least one processor, a task associated with the task identification information;
receiving, from a machine learning server, by the at least one processor, a current transition cost associated with the task, the current transition cost corresponding to an amount of resources used in transitioning between a current web page associated with the current web page identification information to a new web page associated with the new web page identification information;
selecting, by the at least one processor, and based on the task and the current transition cost, at least one optimization pattern used to optimize the current transition cost;
responsive to selecting the at least one optimization pattern, generating, by the at least one processor, one or more commands directing the machine learning server to execute the at least one optimization pattern;
sending, via the communication interface, by the at least one processor, and to the machine learning server, the one or more commands directing the machine learning server to execute the at least one optimization pattern;
calculating, by the at least one processor, and based on a time for the first user device to transition between the current web page to the new web page using the at least one optimization pattern executed at the machine learning server, an updated current transition cost; and
sending, by the at least one processor, via the communication interface, and to the machine learning server, the updated current transition cost.

19. The method of claim 18, comprising:
determining, by the at least one processor, and based on the task, a first web page associated with a first link from the new web page and a second web page associated with a second link from the new web page;
receiving, by the at least one processor, and from the machine learning server, a first transition cost associated with an amount of resources used in transitioning between the new web page to the first web page;
selecting, by the at least one processor, and based on the task and the first transition cost, at least one optimization pattern used to optimize the first transition cost;
responsive to selecting the at least one optimization pattern used to optimize the first transition cost, generating, by the at least one processor, one or more commands directing the machine learning server to execute the at least one optimization pattern used to optimize the first transition cost;
sending, via the communication interface, by the at least one processor, and to the machine learning server, the one or more commands directing the machine learning server to execute the at least one optimization pattern used to optimize the first transition cost;
calculating, by the at least one processor, and based on a first time for the first user device to transition between the new web page to the first web page using the at least one optimization pattern executed by the machine learning server, an updated first transition cost; and
sending, via the communication interface, by the at least one processor, and to the machine learning server, the updated first transition cost.

20. One or more non-transitory computer-readable media storing instructions that, when executed by a computing platform comprising at least one processor, memory, and a communication interface, cause the computing platform to:
receive, via the communication interface, from a first user device, a web page request comprising current web page identification information, new web page identification information, and task identification information;
identify a task associated with the task identification information;
receive, from a machine learning server, a current transition cost associated with the task, the current transition cost corresponding to an amount of resources used in transitioning between a current web page associated with the current web page identification information to a new web page associated with the new web page identification information;
select, based on the task and the current transition cost, at least one optimization pattern used to optimize the current transition cost;
responsive to selecting the at least one optimization pattern, generate one or more commands directing the machine learning server to execute the at least one optimization pattern;
send, via the communication interface and to the machine learning server, the one or more commands directing the machine learning server to execute the at least one optimization pattern;
calculate, based on a time for the first user device to transition between the current web page to the new web page using the at least one optimization pattern executed by the machine learning server, an updated current transition cost; and
send, via the communication interface and to the machine learning server, the updated current transition cost.
